(19) United States
(12) Patent Application Publication
(10) Pub. No.: US 2015/0354669 A1
(43) Pub. Date: Dec. 10, 2015

(54) GEARBOX FOR AN ADJUSTABLE VEHICLE STABILIZER, AND VEHICLE STABILIZER

(71) Applicant: ZF FRIEDRICHSHAFEN AG, Friedrichshafen (DE)

(72) Inventor: Yüksel EKÖZ, Friedrichshafen (DE)

(21) Appl. No.: 14/760,732

(22) PCT Filed: Jan. 9, 2014
(86) PCT No.: PCT/EP2014/050293

§ 371 Date: Jul. 14, 2015

(30) Foreign Application Priority Data
Feb. 12, 2013 (DE) 10 2013 202 258.1

(51) Int. Cl. F16H 1/46; B60G 21/055

(52) U.S. Cl. CPC F16H 1/46; B60G 21/0553

(57) ABSTRACT

A gearbox (8) for an adjustable vehicle stabilizer (1) with two stabilizer sections (2a, 2b) that can be twisted relative to one another and comprise a first planetary gear stage (P1) which has at least a sun gear (P11), a ring gear (P12), a planetary carrier (P13). Planetary gears (P14) are rotatably positioned on rotating axles (D) of the planetary carrier (P13) whereby the planetary gears (P14) mesh with the sun gear (P11) and the ring gear (P12). Each rotating axle (D) of the planetary carrier (P13) are provided with are at least two planetary gears (P14) that are separated from one another and each meshing with the sun gear (P11) and the ring gear (P12). The vehicle stabilizer (1) is arranged within a gearbox (8).

This application is a National Stage completion of PCT/EP2014/050293 filed Jan. 9, 2014, which claims priority from German patent application serial no. 10 2013 202 258.1 filed Feb. 12, 2013.

### FIELD OF THE INVENTION

The invention concerns a gearbox with an adjustable vehicle stabilizer with two stabilizer sections, that rotate in relation to each other, and a vehicle stabilizer with such a gearbox.

### BACKGROUND OF THE INVENTION

In order to increase the drive comfort, it is known that a chassis stabilizer in a vehicle, meaning a vehicle stabilizer, can be designed to be adjustable. This is done using a vehicle stabilizer with an actuator and two stabilizer sections (torsion rod halves), which are rotatable with respect to each other by means of the actuator. In this case, through rotation of the stabilizer sections, a targeted sway movement of the vehicle body can be created, or swaying movement of the vehicle body, which is created by external factors, can be specifically counteracted. Often, a hydraulic swivel motor is used as an actuator, which enables the easy creation of required torques for the stabilizer adjustment, meaning for the rotation of the two stabilizer sections which, however, requires in comparison a costly energy supply with a pump and valves. Therefore, vehicle stabilizers have been developed were an electric motor serves as the drive. To be able to reduce the size of the electric motor, such a vehicle stabilizer usually has a mechanical gearbox to create the gear ratio for the torque of the electric motor.

Such gearboxes or vehicle stabilizers, respectively, are known through DE 10 2007 031 203 A1 and DE 198 50 169 C1. These known gearboxes are designed as multi-step planetary transmissions, and are connected in series with regard to the drive. The gear ratio and thus the torque increases with each planetary gear step. To safely transfer the increasing torque, without damage to the gear wheels of the planetary gear steps, the width of the teeth of the planet gears increase in the direction of the output.

Hereby, the different types of planet gears, which need to be used in such a gearbox, are increasing. For instance, in the gearbox with three planetary gear steps of DE 198 50 169 C1 (see FIG. 2), each planetary gear step requires its own type of planet gear which are different in their tooth width. Thus since there is just a small number of identical parts, such a gearbox has a relatively large production effort which leads to an increased manufacturing cost. In addition, planet gears or rather gear wheels with a large tooth width undergoing more stress at the tooth flange edges, due to the inconsistent load distribution over the tooth width, as compared to the center of the gear wheel. To avoid this, the gear wheels are designed in a convex manner, which also causes an increase in the manufacturing effort and also larger costs.

### SUMMARY OF THE INVENTION

Thus, it is the task of the invention to create a design for an adjustable vehicle stabilizer which can reduce the manufacturing effort or rather the manufacturing costs of a gearbox.

This task will be solved by a gearbox having the characteristics described below. Thus, this invention concerns a gearbox with an adjustable vehicle stabilizer with two stabilizer sections that are rotatable relative to each other, or rather a vehicle stabilizer gearbox. The gearbox has at least a first planetary gear stage, which has at least a sun gear, a ring gear, a planetary carrier and on axles of rotation of the planet carrier rotatably supports planet gears, wherein the, planet gears mesh with the sun gear and the ring gear. In accordance with the invention, at least two planet gears, that are independent from each other, are provided for each rotational axle of the planet carrier and each of which mesh with the sun gear and the ring gear. In other words, a plurality of axially, successively arranged planet gears are provided on each rotational axle of the planet carrier, instead of a single planet gear, each meshing the same sun gear and ring gear.

Therefore, the planetary gear stage of the gearbox has, instead of just one single planet gear located on each axle and having a relatively large tooth width, two or more planet gears with a relatively small tooth width. Because of the increased number of planet gears for each rotation axle, the surface pressure in the areas of contact area of the gears remains constant in comparison to just a single planet gear, however, because of the simpler manufacturing of the shorter planet gears, the total cost of the gearbox is reduced since the planet gears through their shorter design do not need to be constructed as being convex.

In one embodiment of the invention, at least two planet gears, which are each positioned on a rotation axle, are each of the same design, in particular all planet gears of the first planetary gear stage are all of the same construction. The number of the required planet gears is hereby significantly reduced, meaning that the number of the same parts increases, whereby the manufacturing cost goes down. Manufactured with the same design means in this context in particular that the planet gears have the same dimensions and tolerances, as well as using the same material. The same manufacturing processes for their production are also preferred.

In a further embodiment, the gearbox has a second planetary gear stage which is operationally linked with the first planetary gear stage and which also has at least a sun gear, a ring gear, and a planetary carrier, and has planet gears rotatably positioned on the rotation axles of the planetary carrier. The planet gears of the first and second planetary gear stages are constructed in the same manner. Thus, a further increase of identical parts of the gearbox can be achieved. In an additional embodiment hereof, the second planetary gear stage has exactly one planet gear rotatably supported on each rotation axle of the planetary carrier. It means that this planetary gear stage forms the one with the least amount of planet gears for each rotation axle of the planetary carrier.

The gearbox can have a drive motor which drives the second planetary gear stage for a rotation towards each other of the two stabilizer sections, whereby these drive again the first planetary gear stage. In other words, the second planetary stage is arranged, with the lower or rather lowest number of planet gears for each rotation axle (i.e. exactly one) operationally at the drive of the gearbox, meaning at the driven end of the gearbox or rather at the drive motor and in the first planetary gear stage with the two or more planet gears supported on each location axle, is located at the output of the gearbox, meaning at the output end of the gearbox. Thus, the number of planet gears for each rotation axle increases from the drive side to the output of the gearbox, corresponding to the present torque at the respective planetary gear stage. The drive motor and the gearbox create comprise an actuator which is positioned between the stabilizer sections of the vehicle stabilizer.

In addition, the gearbox can also have one or more additional planetary gear stages which is operationally connected with the second planetary gear stage, and which each has at least a sun gear, a ring gear, a planetary carrier, and on rotating axles of the planetary carrier rotatably positioned planet gears, wherein the planet gears of the one additional planetary gear stage, and if present, of the other additional planetary gear stages are of the same design compared to the first and the second planetary gear stage. Thus, maximizing of the same parts for the gearbox can be achieved.

In a further embodiment hereof, the number of planet gears for each rotation axle of the planetary carrier increases from planetary gear stage to planetary gear stage, starting from a drive side of the gearbox towards an output of the gearbox. Thus, the number of planet gears for each rotation axle increases, corresponding to the torque transferred to the respective planetary gear stage, whereby in each case the occurring surface pressure between planet gears and the sun or respectively the ring gear, in the direction of the output is mainly constant or is at least not critical.

It is noted that the first and, if present, the second planetary gear stage, and if present, the third and other additional gear ratio stages at the gear ratio in particular for slow drive have therefore a gear ratio (=input rotation speed divided by output rotation speed) larger than 1.

In an embodiment of the gearbox, the planet gears, which are positioned together on one of the rotation axles of the planetary carrier, the ratio between the total tooth width and the partial circle diameter (sum of the individual tooth widths of the planet gears on the rotation axle divided by the partial circle diameter), which is larger than 1.3. Normally, the value of 1.1 to 1.25 is desired with gear wheels, but otherwise, the load on tooth flanges over the tooth width is not homogenous, meaning that the edge areas of the tooth flange experience more load than the center area. To counteract this, the gear wheel has in practice a convex design, which increases however significantly the cost of such a gear wheel. Through the distribution of the load, instead of just one single planet gear for each rotation axle to several axially positioned planet gears in a row, each individual planet gear has a ratio of tooth width to partial circle diameter that is significantly lower than 1.3, therefore, it does not need to be designed as being convex. The ratio between the total tooth widths and the partial circle diameter is then, however, above that value. Thus, the same torque transfer capability results at a lower cost.

The invention finally refers also to a vehicle stabilizer having at least two relatively rotatable portions and with a gearbox according to the invention, as mentioned above and explained, for twisting of each of the two stabilizer sections.

### BRIEF DESCRIPTION OF THE DRAWINGS

In the following, the invention is further explained based on the schematic drawings of preferred embodiments, from which further preferred characteristics of the invention can be seen. These show:

FIG. 1 an overall view of a vehicle stabilizer

FIG. 2 sectional view through an actuator for a vehicle stabilizer

### DETAILED DESCRIPTION OF THE PREFERRED EMBODIMENTS

Same parts, or parts which assume the same function, are marked in the drawings with the same reference characters.

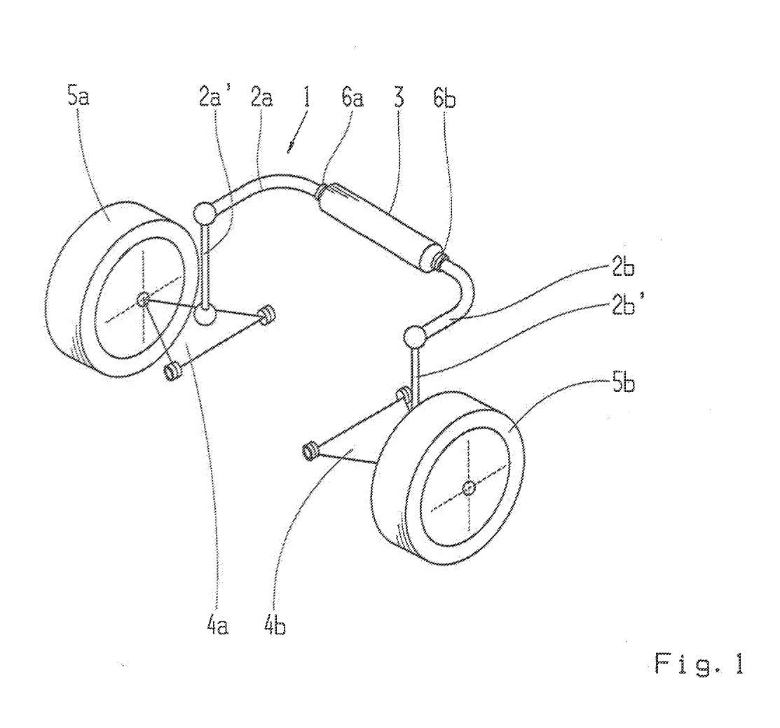

FIG. 1 shows a principle drawing of a vehicle stabilizer 1. The stabilizer 1 has two stabilizer sections 2a, 2b, opposite to each other, and an actuator 3 positioned between the stabilizer sections 2a, 2b. In each case, the stabilizer section 2a, 2b is connected through a hinged support 2a′, 2b′ to a wheel suspension 4a, 4b or rather a vehicle wheel 5a, 5b. Two stabilizer bearings 6a, 6b rotatably connect the vehicle stabilizer 1 to a vehicle body, not shown, that is, a vehicle chassis. It is hereby mentioned that the hinged supports 2a′, 2b′ can also be constructed as one piece with each of the connected stabilizer sections 2a, 2b. An alternative name for the stabilizer sections 2a, 2b is for instance a torsion rod part or torsion rod half,

During a compression movement or rebound movement of the vehicle wheels 5a, 5b, the respective stabilizer section 2a, 2b experiences bending or torsion, whereby the compression or rebound movement is transferred through the actuator 3 and the other stabilizer section 2b, to the other of the vehicle wheels 5a, 5b. A rolling motion of the vehicle chassis can hereby be diminished. During an actuation of the actuator 3, the stabilizer sections 2a, 2b are “artificially” tensioned, meaning twisted against each other, whereby a targeted rolling motion of the vehicle chassis can be established, or an externally created rolling motion, for instance when driving through a curve, can be specifically counteracted to or completely suppressed. Thus, the drive comfort can be significantly increased by means of such an active vehicle stabilizer 1.

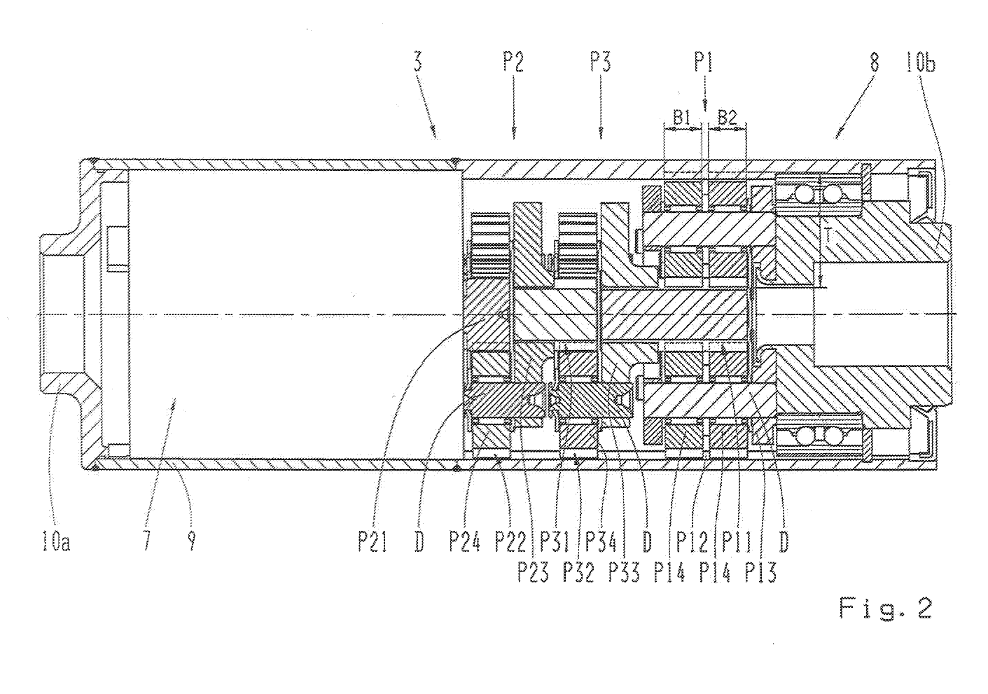

FIG. 2 shows a sectional view of the actuator 3 of FIG. 1. As can be seen here, the actuator 3 has essentially a drive motor 7, as well as a gearbox 8. They are positioned in a common housing 9. This is designed as having a hollow cylindrical shape but can also be adapted to an existing mounting space, or can be designed differently. A first flange 10a serves as an axial termination of the housing 9 and as a means of connecting to the not shown first stabilizer section 2a, and is fixed to the housing 9. A second flange 10b serves as an opposite axial end of the housing 9 and also as means of connecting to the not shown second stabilizer section 2b, but it is rotatably arranged in the housing 9. The stabilizer sections 2a, 2b, in the installed condition, are connected with the respective flanges 10a, 10b in a rotationally fixed manner.

The drive motor 7 of the actuator 3 is in the present case designed, in particular, as an electric motor. Alternatively, it can also be designed as a hydraulic motor or rotational movement can be created differently.

The gearbox 8 has a first planetary gear stage P1 which comprises a sun gear P11, a ring gear P12, a planetary carrier P13, as well as several planet gears P14, positioned on rotating axles D of the planetary carrier P13. In the shown example, two planet gears P14 are provided on a common rotating axle D. That number can also be increased, for instance, to three gears. The planet gears P14 on each rotating axle D are separated from each other but they mesh, however, with the same sun gear P11 and the same ring gear P 12. In addition, the planet gears P14 are equally designed in reference to each other. The planetary carrier P13 serves as the output of the first planetary gear stage P1 and for the gearbox 8, which is connected in a rotationally fixed manner with the second flange 10b and drives it accordingly. The sun gear P11 serves as the input to the first planetary gear stage P1.

In addition, the gearbox 8 as a second planetary gear stage P2 which also comprises a sun gear P21, a ring gear P22, a planetary carrier P23, as well as several planet gears P24 that are rotatably positioned on rotating axles D of the planetary carrier P23. In the shown example, the second planetary gear stage P2 has for each rotating axle D a single planet gear P24, however, several gears can be provided. The plane gears P24 of the second planetary wheel stage P2 are identical to each other and also in comparison to the gears of the first planetary wheel stage P1. The planetary carrier P23 serves as the output of the second planetary wheel stage P2 while the sun gear P21 serves as the input. The sun gear P21 creates therefore at the same time the input to the gearbox 8. It is at least connected in a rotationally fixed manner with a not shown output shaft of the drive motor 7, or the output shaft of the drive motor 7 represents directly the sun gear P21, and has at that time a respective tooth shape.

Finally, the gearbox 8 comprises a third planetary gear stage P3 which also has a sun gear P31, a ring gear P32, a planetary carrier P33, as well as several planet gears P34 rotatably positioned on rotating axles D of the planetary carrier P33. In the shown example, the third planetary gear stage P3 has for each rotating axle D a single planet gear P34, but several gears can be provided, in particular, two. The planet gears P34 of the third planetary gear stage P2 are identical to each other, and also in comparison to the gears of the first and second planetary gear stages P1, P2. The planetary carrier P33 serves as output of the third planetary gear stage P3, while the sun gear P31 serves as the input. Hereby, the sun gear P31 is at least connected in a rotationally fixed manner with the planetary carrier P23 of the second planetary gear set P23, and the planetary carrier P33 with the sun gear P11 of the first planetary gear set P1.

The drive of the vehicle stabilizer 1 for its adjustment happens, in accordance with FIGS. 1 and 2, through the drive motor 7 which drives the second planet gear set P1 which in turn drives the third planet gear set P3, which then drives the first planet gear set P1, which finally rotates the flange 10b in the housing 9, and therefore creates a rolling motion of the stabilizer sections 2a, 2b.

The ring gears P12, P22, P23 are formed, in the embodiment shown in FIG. 2, by a common, sleeve shaped part with inner gearing, which is at least connected in a rotationally fixed manner with the housing 9, and which is, for instance, axially inserted into this. Alternatively, one or all ring gears P12, P22, P23 can be designed as single parts which are fixed to the housing 9.

The rotation axles D of the illustrated planetary gear sets P1, P2, P3 are fixed to the respective planetary carrier P13 while the planet gears P14 thereon are rotatably and floatingly supported by needle bearings or sliding bearings etc. The rotation axles D of the respective planet gears P14, P24, P34 are particularly evenly distributed in the circumferential direction on the respective planetary carriers P13, P23, P33, In particular, the rotation axles D are designed as bolts. If more than one planet gear P14, P24, P34 is positioned on a rotation axle D, one or more spacers can be positioned between these planet gears P14, P24, P34, so as to prevent direct contact of the planet gears P14, P24, P34 with each other. The number of the planet gears P14, P24, P34 for each rotation axle increases, in particular, linearly with the individually transferred torque of the planetary gear stages P1, P2, P3, the first planetary gear stage P1, for instance, has as exactly 3 planet gears P14 for each rotating axle D, the second planetary gear stage P2 as at that time exactly one planet gear P24 for each rotating axle D, while at that time the third planetary gear stage P3 has exactly two planet gears P34 for each rotating axle D.

It is also noted that the gearbox 8 can also have, instead of three planetary gear stages P1, P2, P3, just the first planetary gear stage P1, or can have a first and a second planetary gear stage P1, P2. In the latter, the planetary carrier P23 in particular is directly connected in a rotationally fixed manner with the sun gear P11, meaning without an intermediate gear ratio stage. Of course, instead of or in addition to the second or third planetary gear stage P2, P3, one or more gear ratio stages can be provided which are designed differently, for instance as a gear ratio stage designed as a harmonic drive or as a simple spur gear stage.

It has become clear that those planet gears P14, P24, P34 which are positioned on a common rotating axle D need to be designed in a way that the ratio between the total tooth width B1+B2 of these planet gears P14, P24, P34 (meaning the sum of the individual tooth widths B1+B2) and the pitch circle diameter T of these planet gears P14, P24, P34 has a value of larger than 1.3. The ratio between the individual tooth widths B1, B2 and T are drawn in FIG. 2 as an example of the planet gears P14 of the first planet gear set P1.

### REFERENCE CHARACTERS

1 Vehicle Stabilizer
2a, 2b Stabilizer Section
2a′, 2b′ Hinged Support
3 Actuator
4a, 4b Suspension
5a, 5b Vehicle Wheel
6a, 6b Stabilizer Bearing
7 Drive Motor
8 Gear Box
9 Housing
10a, 10b Flange
B1, B2 Tooth Width
D Rotating Axle
P1, P2, P3 Planetary gear stage
P11, P21, P31 Sun Gear
P12, P22, P32 Ring Gear
P13, P23, P33 Planetary Carrier
P14, P24, P34 Planet gear
T Pitch Circle Diameter

1-9. (canceled)

10. A gearbox (8) for an adjustable vehicle stabilizer (1) having two stabilizer sections (2a, 2b) that are adjustable relative to each other, the gearbox comprising:
a first planetary gear stage (P1) which has at least a sun gear (P11), a ring gear (P12), a planetary carrier (P13) and planet gears (P14) that are rotatably positioned on rotating axles (D) of the planetary carrier (P13),
the planet gears (P14) meshing with the sun gear (P11) and the ring gear (P12),
each rotating axle (D) of the planetary carrier (P13) having at least two planet gears (P14) that are separated from one another, and each of the planet gears (P14) meshing with the sun gear (1) and the ring gear (12).

11. The gearbox (8) according to claim 10, wherein the two planet gears (P14), each positioned on the rotating axle (D), are identical to one another.

12. The gearbox (8) according to claim 11, wherein the gearbox (8) has a second planetary gear stage (P2), which is operationally connected to the first planetary gear stage (P1) and which has at least a sun gear (P21), a ring gear (P22), a planetary carrier (P23), and planet gears (P24) that are rotatably positioned on rotating axles (D) of the planetary carrier (P23) of the second planetary gear stage, the planet gears (P24) of the first and the second planetary gear stages (P1, P2) are identical to one another.

13. The gearbox (8) according to claim 12, wherein only one planet gear (P24) is rotatably positioned on each of the rotating axles (D) of the planetary carrier (P23) of the second planetary gear stage (P2).

14. The gearbox (8) according to claim 12, wherein the gearbox (8) has a drive motor (7) which drives the second planetary gear stage (P2) which then drives the first planetary gear stage (P1), for the twisting motion of the two stabilizer sections (2a, 2b) towards one another.

15. The gearbox (8) according to claim 12, wherein the gearbox (8) has at least one additional planetary gear stage (P3) which is operationally connected with the first and the second planetary gear stages (P1, P2), and each of the at least one additional planetary gear stage has at least a sun gear (P31), a ring gear (P32), and a planetary carrier (P33) which rotatably supports planet gears (P34) on rotating axles (D) thereof, the planet gears (P34) of the at least one additional planetary gear stage (P3) are identical with one another and with the planet gears of the first and the second planetary gear stages (P1, P2).

16. The gearbox (8) according to claim 15, wherein a number of the planet gears (P14, P24, P34) for each of the rotating axles (D) of the planetary carriers (P13, P23, P33) of the first, the second and the at least one additional planetary gear stages increases, starting from a drive input side of the gearbox (P21) towards an output side (P13) of the gearbox (8).

17. The gearbox (8) according to claim 10, wherein the planet gears (P14, P24, P34), which are positioned on one of the rotating axles of the planetary carrier (P13, P23, P33) of the first planetary gear stage, have a ratio, between total tooth width (B1+B2) and a pitch circle diameter, that is greater than 1.3.

18. A vehicle stabilizer (1) in combination with a gearbox (8), the vehicle stabilized being adjustable and having two stabilizer sections (2a, 2b) that are adjustable relative to one another, the gearbox comprising a first planetary gear stage (P1) which has at least a sun gear (P11), a ring gear (P12), a planetary carrier (P13) and planet gears (P14) that are rotatably positioned on rotating axles (D) of the planetary carrier (P13), the planet gears (P14) mesh with the sun gear (P11) and the ring gear (P12), each of the rotating axles (D) of the planetary carrier (P13) has at least two planet gears (P14) that are separated from one another, and each of the planet gears (P14) mesh with the sun gear (11) and the ring gear (12).

19. A gearbox for an adjustable vehicle stabilizer having two stabilizer sections that are adjustable with respect to each other, the gearbox comprising:
first, second and third planetary gear stages, and each of the first planetary gear stage, the second planetary gear stage and the third planetary gear stage having a sun gear, a ring gear and a planetary carrier;
the planetary carriers of the first, the second and the third planetary gear stages each have carrier rotational axles which rotatably support planet gears;
each of the carrier rotational axles of the first planetary gear stage rotationally supports three planet gears, the planet gears of the first planetary gear stage are spaced from one another and each meshing with the sun gear and the ring gear of the first planetary gear stage;
each of the carrier rotational axles of the second planetary gear stage rotationally supports only one planet gear, and each of the planet gears of the second planetary gear stage meshing with the sun gear and the ring gear of the second planetary gear stage;
each of the rotational axles of the third planetary gear stage rotationally supporting two planet gears, and the planet gears of the third planetary gear stage are spaced from one another and each meshing with the sun gear and the ring gear of the third planetary gear stage; and
the planet gears of the first, the second and the third planetary gear stages are identical with one another.

20. The gearbox according to claim 19, wherein the sun gear of the second planetary gear stage is connected, in a rotationally fixed manner, to a drive output of a drive motor, the planet carrier of the second planetary gear stage is connected, in a rotationally fixed manner, to the sun gear of the third planetary gear stage, the planet carrier of the third planetary gear stage is connected, in a rotationally fixed manner, to the sun gear of the first planetary gear stage, and the planet carrier of the first planetary gear stage is connected, in a rotationally fixed manner, to a drive output flange.

21. The gearbox according to claim 20, wherein the ring gears of he first, the second and the third planetary gear stages are connected, in a rotationally fixed manner, to a common housing of the drive motor and the gearbox.
